(19) United States
(12) Patent Application Publication
(10) Pub. No.: US 2008/0159288 A1
(43) Pub. Date: Jul. 3, 2008

(54) TRAFFIC ENGINEERING AND FAST PROTECTION USING IPv6 CAPABILITIES

(75) Inventors: Ramesh Nagarajan, Junction, NJ (US); Shyam P. Parekh, Orinda, CA (US); Kiran M. Rege, Marlboro, NJ (US)

Correspondence Address: SYNNESTVEDT & LECHNER, LLP, 1101 MARKET STREET, SUITE 2600, PHILADELPHIA, PA, 19107-2950, US

(73) Assignee: LUCENT TECHNOLOGIES INC., Murray Hill, NJ (US)

(21) Appl. No.: 11/617,843

(22) Filed: Dec. 29, 2006

(51) Int. Cl. H04L 12/56

(52) U.S. Cl. 370/392; 370/238

(57) ABSTRACT

The present invention provides a method for traffic engineering and fast protection of individual data flows using capabilities supported by IPv6. By utilizing IPv6 extension headers and flow labels a specific network route based upon quality of service (QoS) requirements of a data flow can be selected by a source node. Once a route meeting the QoS requirements of the data flow is selected, a source node can insert the route in an initial packet header and force the flow along the corresponding network path. The source and intermediate nodes cache the route and the flow label selected for a data flow. For subsequent packets, the flow label is used by intermediate nodes to determine the next hop along the route. In the event of a failure, an intermediate node can force the insertion of a new route (along with the original flow label) in the next packet belonging to the failed data flow so that, as the packet is forwarded toward the destination, intermediate nodes on this new path can cache the route and the corresponding flow label. This new route is then used to continue forwarding the data flow to the destination node.

### FIELD OF THE INVENTION

The invention is directed towards traffic engineering in packet-based networks, specifically IP packet-based networks.

### BACKGROUND OF THE INVENTION

Quality of service (QoS) requirements of packet-based networks have become a great concern as network demands have increased in the past few years. One particular QoS requirement of concern is traffic engineering, or source-destination route selection. A further requirement with traffic engineering is quick recovery via alternate route selection when a link selected in the original source-destination route fails or otherwise becomes unavailable.

In IP networks based on link state routing, e.g., OSPF, nodes on the network maintain a network topology table, or a listing of node-to-node links throughout the network along with the corresponding characteristics. By utilizing this table, a source node can construct a source-destination route and begin transmission of a data flow.

A current standard for traffic engineering in IP networks is Multiprotocol Label Switching (MPLS). In MPLS, Label Switched Paths (LSPs) can be created along any desired route in the network based on the QoS requirements of the flows to be carried over the path. Essentially, an LSP is a virtual connection, or a path chosen through the network using the information provided by a routing protocol. While the topological information required for construction of LSPs can be disseminated using a standard routing protocol, the packets themselves are switched based on the fixed-length LSP labels. This provides for efficient packet forwarding based on referencing routing tables indexed by the LSP labels. Basically, by using a packet's LSP label to identify the corresponding next hop, i.e. the next node on the route, each routing node in the route can quickly determine the next link over which the packet is to be forwarded.

While efficient for forwarding packets, this approach has limitations when it comes to fast recovery from route failures. MPLS provides means for fast protection in an IP network by pre-establishing alternate LSPs on node paths. Traffic is switched to this alternate LSP upon failure of the primary path. A major drawback to this approach is that the alternate LSPs have to be pre-established for fast protection as signaling to set up new LSPs after failure requires a long time in comparison to the time required to switch the traffic to a pre-established LSP. This arrangement has the additional drawback that these alternate paths chosen to replace a faulty LSP may not be the most efficient based upon current network conditions.

Another method that exists for routing packets along designated routes is source routing. By using features in IPv4 (Internet Protocol version 4), such as an options field in the header, a source can label the entire route that it chooses for a packet to follow. In source routing, every packet must have the entire route in the header. This leads to additional costs, as each routing node on the path must check each header for the path and determine the next hop. Also, as each packet contains the entire source-destination route, the size of each packet increases.

Recently, IPv6 (Internet Protocol version 6) was approved as a means to alleviate the IP address exhaustion problem. Specifically, the number of IP addresses allocated for by IPv4 is being exhausted. Along with providing more address space, IPv6 also provides additional capabilities to improve QoS. One of these capabilities is the use of extension headers, or headers used dynamically by a node to include additional information in the packet.

### SUMMARY OF THE INVENTION

The present invention provides a method for traffic engineering and fast protection of individual data flows using capabilities supported by IPv6. In this method, a specific network route based upon QoS requirements of a data flow, i.e., required bandwidth and delay constraints, and a flow label for the data flow can be selected by a source node. Once a route meeting the QoS requirements of the data flow and the corresponding flow label are selected, a source node can insert the route and the flow label in an initial packet header and force the flow along the corresponding network path. The insertion of the route into the initial packet header utilizes the capabilities of IPv6 hop-by-hop extension headers. The flow label is carried in the “flow label” field of the IPv6 fixed header. The source and intermediate nodes cache the route and the flow label selected for a data flow. For subsequent packets, the flow label is used by intermediate nodes to determine the next hop along the route.

In the event of a link or node failure on the route of a data flow, an intermediate node can divert the data flow along a new route by inserting the new route in the next packet belonging to the data flow so that, as the packet is forwarded toward the destination, intermediate nodes on this new path can cache the route and the flow label associated with the data flow. This new route is computed to be disjoint from the failed segment of the primary path. Note that this alternate route can be pre-computed or computed in real-time and, immediately on receipt of the failure indication, an intermediate node can switch the flow to this alternate route.

### BRIEF DESCRIPTION OF THE DRAWINGS

FIG. 1 is a block diagram illustrating a local area network according to principles of the present invention.

FIG. 2a is a data packet according to IPv6 standards.

FIG. 2b is an Options Field in a Hop-by-Hop extension header.

FIG. 3a is a flow chart illustrating the behavior of a source client according to principles of the present invention.

FIG. 3b is a flow chart illustrating the behavior of an intermediate node according to principles of the present invention.

FIG. 3c is a flow chart illustrating the behavior of a destination client according to principles of the present invention.

FIG. 4 is a data packet containing an extension header for flow setup or change according to principles of the present invention.

FIG. 5 is a data packet containing an extension header for responding to a flow setup or change according to principles of the present invention.

FIG. 6 is a data packet containing an extension header for flow reroute according to principles of the present invention.

FIG. 7 is a data packet containing an extension header for responding to a flow reroute according to principles of the present invention.

FIG. 8 is a data packet containing an extension header for flow termination according to principles of the present invention.

### DETAILED DESCRIPTION OF THE INVENTION

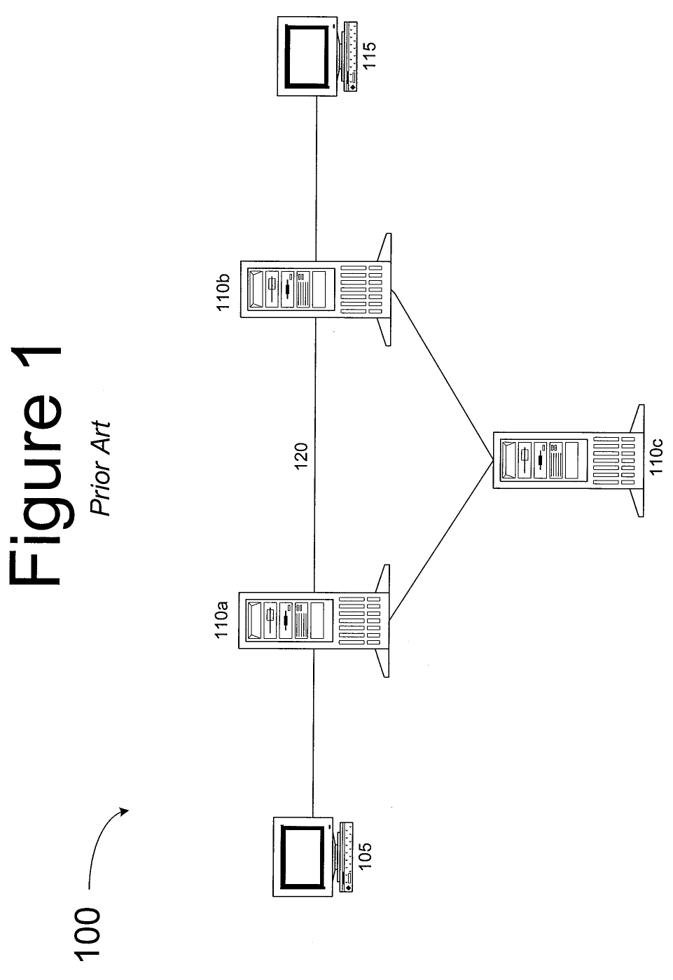

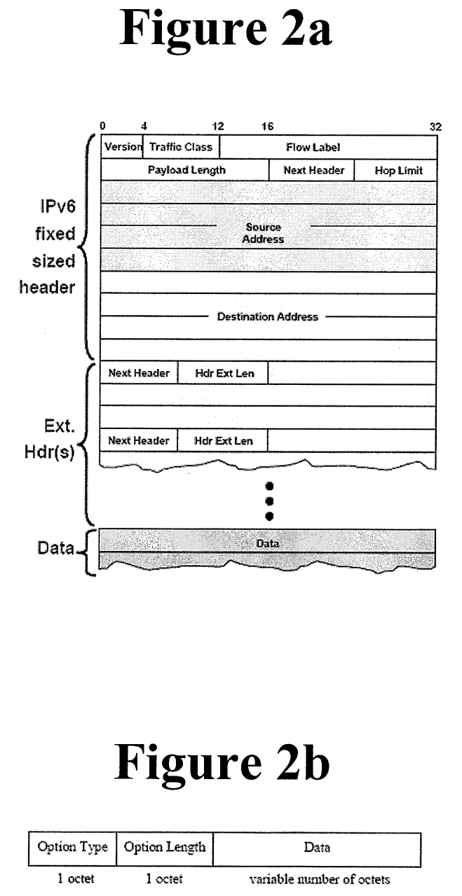

The present invention provides a method and computer program product for utilizing quality of service (QoS) capabilities in IPv6 (Internet Protocol version 6) to improve traffic engineering and fast protection/error control. FIG. 1 illustrates a simple local area network 100. Source client 105 initiates a data flow to destination client 115 by utilizing routers (or servers) 110a and 110b. To direct the data flow to destination client 115, first source client 105 creates an IPv6 header inclusive of an extension header in the first packet of the data flow. Source client 105 inserts the address of the intended destination of the data flow into the packet, in this example the destination address being the network-layer (IP) address of destination client 115. Source client 105 next inserts a flow label to the packet. The flow label is used to identify each packet as belonging to a specific data flow. The source and destination addresses as well as the flow label are carried in the “fixed-header” part of the IPv6 packet header as shown in FIG. 2a. Source client 105 also inserts an optimized route based on links stored in a network topology table. The route is carried in the extension header of the packet. A network topology table is a collection of all links in the network, possibly along with corresponding bandwidths, traffic levels and other relevant parameters, and is used to quickly find paths from one network node to another. In this example, the optimized route is source client 105 to router 110a to router 110b and finally to destination client 115. Router 110a receives the first packet of the data flow from source client 105 and examines the first packet. The first packet received contains the extension header created by source client 105, and the extension header contains the optimized route. Router 110a caches the flow label extracted from the fixed header of the packet and the accompanying optimized route contained in the extension header. Router 110a then forwards the packet to router 110b. Similar to router 110a, router 110b receives the first packet of the data flow and caches the flow label and accompanying optimized route. Finally, router 110b forwards the data flow to the destination client 115. Each additional packet of the data flow sent by source client 105 only needs to be labeled with the flow label. That is, there is no need for these additional packets to carry an extension header containing the source-destination route. As each router along the path receives additional packets, they can use the flow label to identify the next hop for the packets.

Problems may occur along the route, however. For example, connection 120 between router 110a and router 110b could become inactive for various reasons, e.g., physical hardware breakdowns. The optimized route being used to forward the data flow is now incomplete and cannot continue to be used. An alternate path is needed to continue transferring the data flow.

Using existing techniques to recover from a situation such as this requires initiating a new path at the source route. This can be time consuming if the number of nodes on the path is very large. Each node must queue packets belonging to the data flow until the source node can determine a new path and forward the packets along this new path. Additionally, several existing techniques, such as MPLS discussed above, utilize new routes that were determined at the same time the optimized route was chosen. This can lead to the selected new route being ill-suited to carry the data flow to the destination client on account of changes in the operating conditions.

In the present invention, the node immediately preceding the problem, in this example router 110a, will determine a new route to utilize for the forwarding of the packets. In this example, router 110a determines that router 110c can be used to bypass broken connection 120. Router 110a indicates the new route to the nodes involved in routing the data flow by using the same features of IPv6 extension headers that were used by source client 105 to establish the original route. By forming the new route at an intermediate routing node, time is saved as the optimization can occur in real time without the need for every node on the route to queue the data flow until the failure indication propagates to the source client and a result containing a new route propagates to the router preceding the error.

FIG. 2a illustrates a data packet as standardized by IPv6. The present invention makes use of the extension headers introduced in IPv6. The IPv6 specification allows for six types of extension headers: Hop-by-Hop, Routing, Fragment, Destination Options, Authentication, and Encapsulating-Security-Payload. Except for the Hop-by-Hop and Routing extension headers, all the other extension headers are processed only at the node specified by the destination address in the IPv6 header. Routing extension headers are used for source routing, i.e., to list the intermediate nodes to be visited. Hop-by-Hop extension headers are also processed by each intermediate router. Note, however, that the standard only specifies the format/framework but does not suggest any particular uses of or content for these extension headers. These extension headers can be stitched together using the Next Header field 201 as shown in FIG. 2a. Next Header field 201 points to another extension header. When the next header field is encountered, the recipient of the packet infers the next extension header has relevant information. The rationale for adopting such a system is to separate additional services from basic services, put them in extension headers, and further categorize extension headers by their function. By doing so, the burden placed on individual routers is lessened, and a system is established that allows flexible addition of functions. Following the Next Header field 201 is Extension Header Length field 202. This field is used to indicate the total length of the corresponding extension header not including the first eight bytes. Following Extension Header Length field 202 come the Option Fields 203.

FIG. 2b illustrates an Options Field 203 of a Hop-by-Hop extension header. Several types of information can be reported in a Hop-by-Hop extension header by exploiting this (i.e., options) feature. The present invention utilizes this feature to indicate the route to be followed by packets associated with the data flow to which the present packet belongs. Note that a single extension header can contain multiple Options Fields, each of which comprises three sub-fields—Option Type, Option Length and Data.

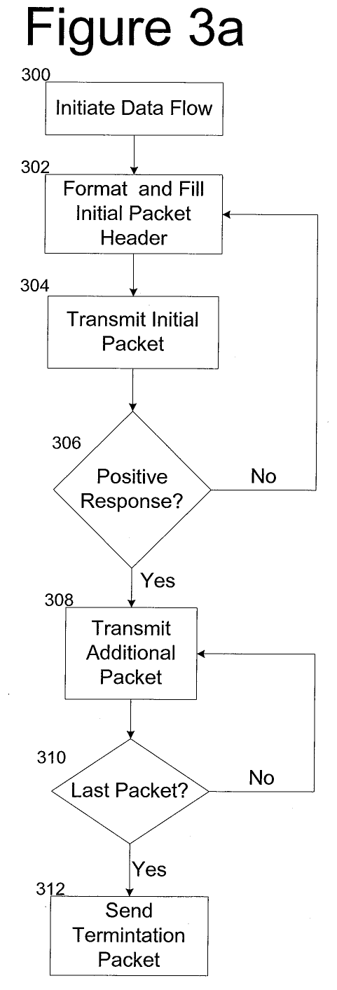

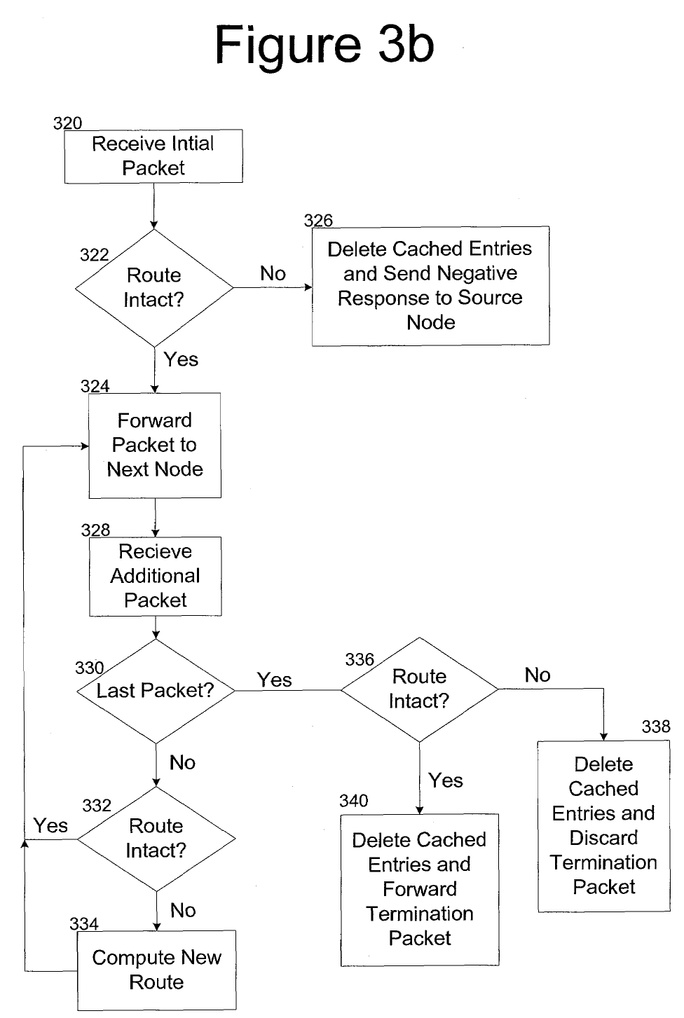

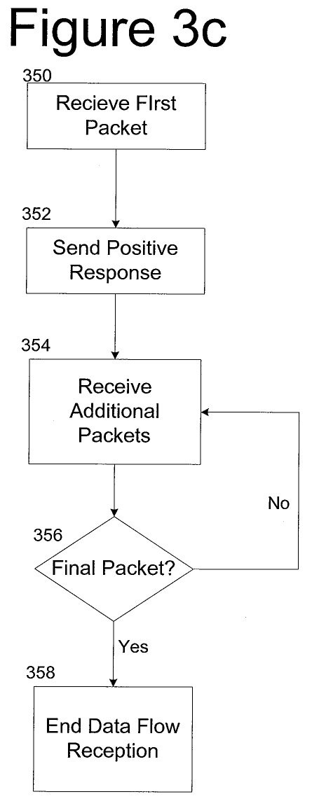

FIGS. 3a-c illustrate the steps taken by each major component in the network (i.e., source client, intermediate nodes and destination client) according to a particular embodiment of the present invention. In this embodiment, the steps required for forwarding a data flow through the network illustrated in FIG. 1 are discussed.

FIG. 3a illustrates the steps taken by the source client. The process begins at step 300. Here, source client 105 initiates a data flow to be forwarded to destination client 115. After initiating a data flow and determining the destination client, source node 105 determines an optimized route to use in forwarding the data flow to the destination. By using a network topology table, source client 105 can quickly determine an optimized route for forwarding the data flow. In this example, the optimized route used is source client 105 to router 110a to router 110b to destination client 115. Source client 105 also selects a flow label for the data flow that is unique within the relevant part of the network.

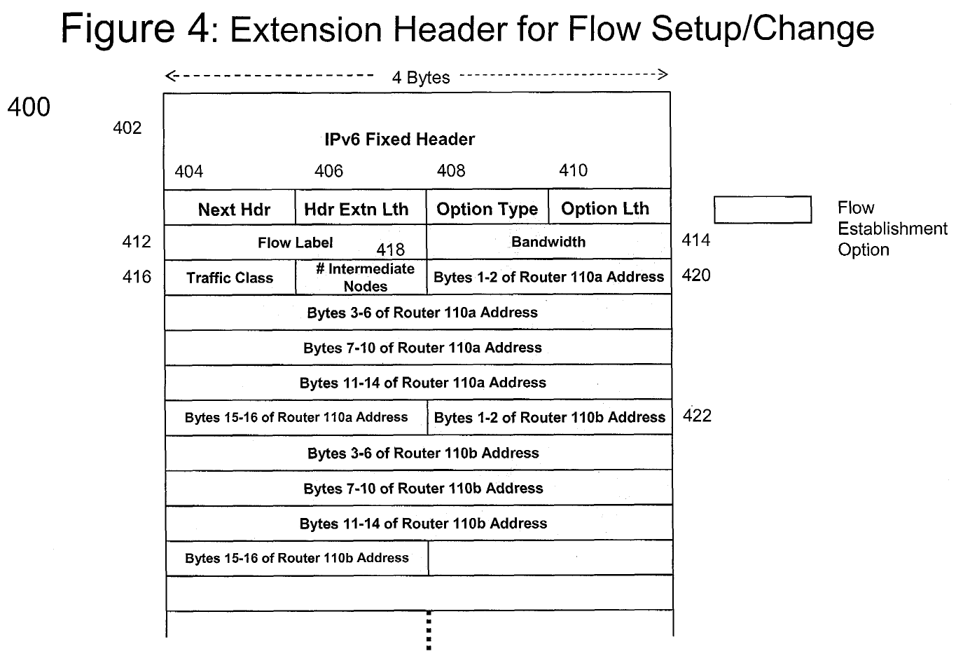

Once source client 105 has determined an optimized route and selected a flow label, the process continues to step 302. At step 302, source client 105 formats a first packet of the data flow to include an extension header which includes the optimized route. FIG. 4 (discussed below) shows the first packet of a data flow, packet 400, which includes an extension header containing an optimized route.

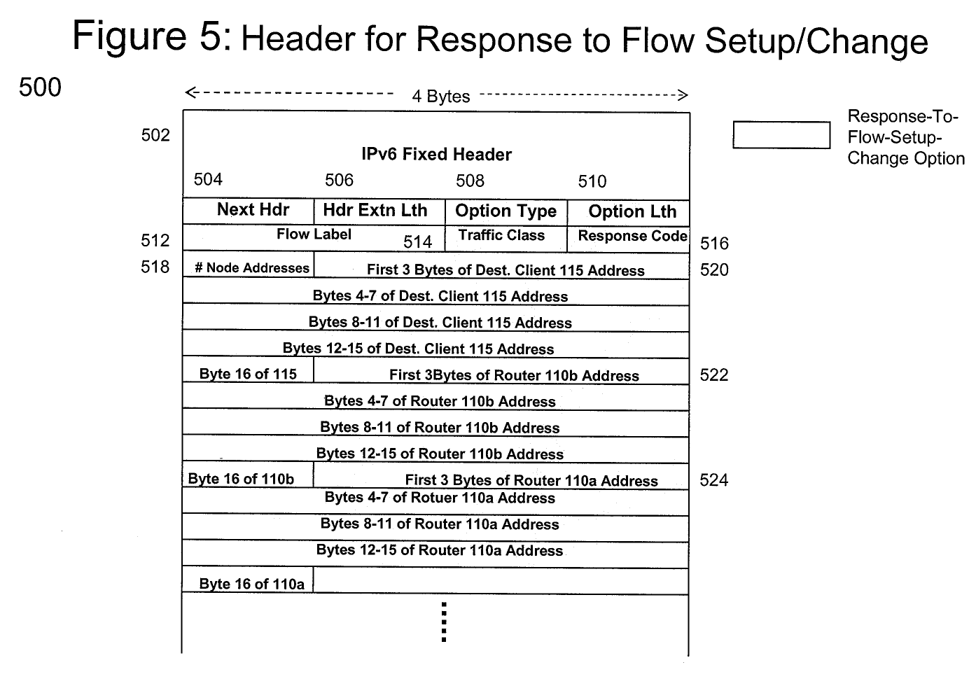

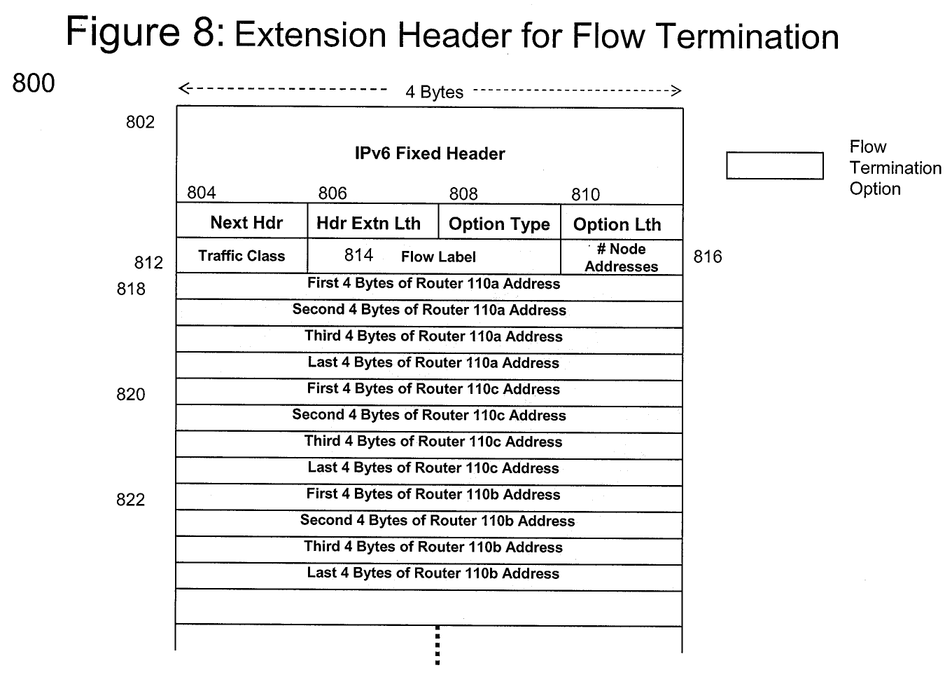

Once the packet header including the extension header for the initial packet is completely filled, the process proceeds to step 304. Here, the source client 105 transmits the initial data packet of the data flow along the optimized route. Once the initial data packet is transferred, the source client 105 waits for a response. One of two responses are possible, a positive response which indicates the data packet reached the destination client 115 or a negative response which indicates the data packet failed to reach the destination client 115. If a negative response is received, the process returns to step 302 where the source client 105 reformats the extension header to include a new optimized route. Then the process proceeds as before. FIG. 5 (discussed in detail below) illustrates a positive response as received from a destination client. If a positive response is received, the process continues to step 308. Here, the source client 105 transmits an additional packet. After transmission, the process proceeds to step 310 where the source client 105 determines if the most recently sent data packet is the last data packet in the data flow. If it is not, the process returns to step 308. If the data packet is the last packet of the data flow, the process proceeds to step 312. Here, the source client 105 sends a termination packet ending the data flow. FIG. 8 (discussed in detail below) illustrates a data flow termination packet. Specifically, the data flow termination packet is used to indicate to the intermediate nodes that the data flow is complete and they can delete any cached information they may have stored with relation to this specific data flow.

FIG. 3b illustrates the steps performed by an intermediate node (e.g., routers 110a and 110b in FIG. 1). At step 320, the intermediate node receives the initial packet of the data flow. This packet contains the optimized route as determined by the source client 105 as well as a flow label. The intermediate node caches the flow label and the optimized route. The process proceeds to step 322 where the intermediate node checks to insure that the optimized route is intact. If the route is not intact, the process proceeds to step 326 where the intermediate node deletes the cached entries, and sends a negative response to the source node. If the route is confirmed as being intact, the process proceeds to step 324. Here the intermediate node forwards the packet to the next node on the optimized route. Once the packet is forwarded, the intermediate node waits for additional packets. At step 328, the intermediate node receives an additional packet. Using the flow label included in the packet, the intermediate node can quickly access the stored optimized route and determine the next node to forward the packet to.

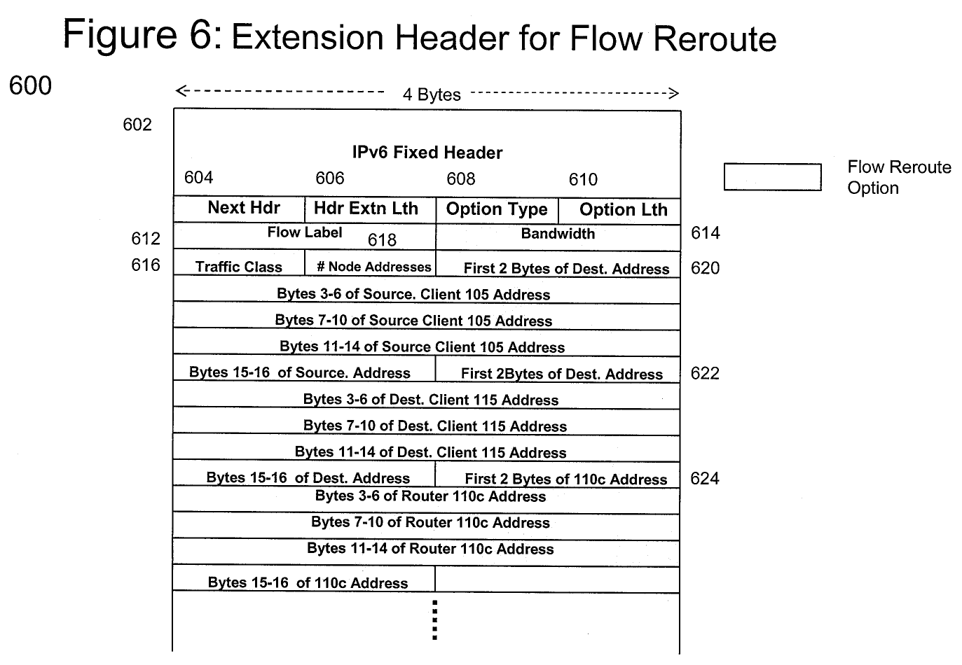

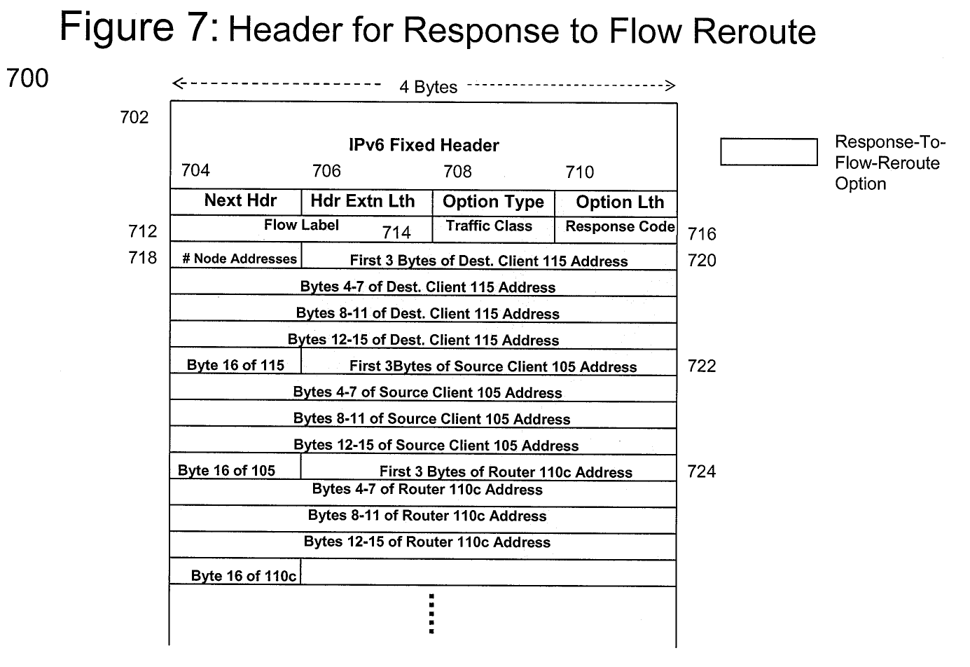

After determining the next node to forward the packet to, the process proceeds to stop 330 where the intermediate node determines if the packet sent is the last packet of a data flow. If the packet is not the last packet of the data flow, the process continues to step 332. Here, as before at step 322, the intermediate node determines if the route is intact. If the route is intact, the process returns to step 324 where the packet is forwarded to the next node on the optimized route. However, if the route is not intact, the process proceeds to step 334 where the intermediate node computes a new route. This new route is computed using the local network topology table stored at the intermediate node. By computing this new route at the intermediate node as opposed to the source node, efficiency is increased as the re-routing happens immediately. If the source node had to be notified to compute a new route, the packet would need to be resent along the new route which would create a much larger delay than in the present invention. FIG. 6 (explained in detail below) illustrates a packet created by an intermediate node indicating a re-route as well as a detailed explanation of how the route is created. Once the new route is created, the re-route packet is sent along the newly created route. The sending intermediate node awaits a response, which can either be positive or negative. FIG. 7 (explained in detail below) illustrates a response packet to a re-route notification and explains in detail how the response is created. If a negative response is received, the intermediate node computes a new re-route. If a positive response is received, the process returns to step 324 and the packet is forwarded to the next node on the route, in this case, the next node on the newly created re-route.

Returning to step 330, if the packet is a flow termination packet associated with the data flow, the process proceeds to step 336. Here, as is done at steps 322 and 332, the intermediate node determines if the route is intact. If the route is not intact, the intermediate node deletes the cached entries associated with the flow and then discards the flow termination packet at step 338. Conversely, if the route is intact, the intermediate node identifies the next hop for the termination packet, deletes the cached entries associated with the flow, and then forwards the termination packet to the next hop node at step 340. ***** Change FIG. 3b to make it consistent with this description. *****

FIG. 3c illustrates the steps performed by a destination client (e.g., destination client 115) according to an embodiment of the present invention. At step 350, a destination client receives the first packet of a data flow containing an extension header listing a flow label and an optimized route. The destination client caches the relevant pieces of information about the flow (e.g. the address of the source client, the flow label, etc.) The process then proceeds to step 352 where the destination client sends a positive response to the source client. This response is used as an indication that the initial data packet reached the destination node and that the optimized route is suitable for forwarding the remainder of the data flow. FIG. 5 (discussed in detail below) illustrates a positive response as created by a destination client. After the response is sent to the source client, the process proceeds to step 354. At this step the destination client receives additional packets. Once an additional packet is received, the destination client determines if the packet is a final, or termination, packet. If the packet is not a termination packet, the process returns to step 354 where additional packets are received. If the packet received is a termination packet, the process proceeds to step 358. At this point, the destination client processes the termination packet and ends reception of the data flow. The cached flow label and optimized route are deleted from memory.

As described above, FIGS. 4-8 illustrate in detail examples of various packets used by the embodiment of the present invention shown in FIGS. 3a-c.

FIG. 4 illustrates packet 400 as used by a source client to initiate a data flow along an optimized route. (Note that the same packet format is used by the source if a data flow to make changes in the parameters associated with the flow.) The first portion of packet 400 is IPv6 Fixed Header 402. Here, the source client 105 inserts its own address as the source address, and the address of destination client 115 as the destination address. Next, source client 105 sets Next Header field 404 to indicate that there is an extension header following. Header Extension Length field 406 is left empty until the extension header has been completely filled. Since various types of extension headers, each with possibly different types of contents, can be concatenated together, this field is used to indicate the length of the corresponding extension header. Next, source client 105 fills Option Type field 408. This field is utilized to indicate that the following extension header will be a hop-by-hop header for establishing a new data flow, meaning that each node on the source-destination route will process the information contained in the extension header. The Option Length field 410 indicates the total length of the fields contained within the scope of the current Option, and is filled in after the source node completes these fields. Next, source client 105 inserts an identifier into the Flow Label field 412. This identifier is used by all nodes on the source-destination route to identify the individual data flow. Next, source client 105 fills in Bandwidth field 414. For certain data flows, a minimum bandwidth may be required (e.g., streaming audio or video). By specifying a minimum bandwidth, a source can ensure that all paths on the source-destination route meet this criterion. After bandwidth, the source client fills in the Traffic Class field 416. This field is used to report the priority or QoS treatment desired for the data flow. Specific indicators can be used to signify that a data flow is of great importance and should be prioritized to the top of any queues along the route.

Once the bandwidth and traffic class have been filled, the source client begins to fill the fields relating to the chosen route. The first field is Number of Intermediate Nodes 418. In this example, source client 105 will insert a “2” into this field as there are two intermediate nodes (i.e., router 110a and router 110b) between source client 105 and destination client 115. Following field 418, source client 105 inserts the network address of router 110a into field 420. Similarly, source client 105 inserts the network address of router 110b into field 422. It is important to note that in this embodiment, the source address and destination address are not inserted into the initial extension header. Only the addresses of the intermediate nodes are inserted into the initial extension header.

Once the intermediate node addresses are inserted into the extension header, the source client can update Option Length field 410 to indicate the total length of the fields contained within the scope of the current Option. The Header Extension field 406 is also filled at this time with the total length of the just-filled extension header. The source client can also add another extension header at this time, such as an extension header containing information for performance monitoring along the source-destination route. Each of these extension headers will begin with “Next Header” and “Header Extension Length” fields, followed by the corresponding contents.

FIG. 5 illustrates an example of a packet 500 created by destination client 115 in response to the initial packet of the data flow. Similar to the process for creating packet 400 in FIG. 4, first destination client 115 fills in IPv6 Fixed Header 502. Here, the address of source client 105 is used as the destination address and the address of destination client 115 is used as the source address (as this confirmation packet is sent back along the route to source client 105). Next, destination client 115 fills in the extension header fields appropriately. It fills in Next Header field 504 appropriately indicating that an extension header is following and leaves Header Extension Field 506 blank until the extension header is complete. Next, destination client 115 fills in Option Type field 508 to indicate the following extension header is a hop-by-hop extension header for responding to a flow setup or change packet. Option Length field 510 is left blank until the extension header is complete. Flow Label field 512 is filled with the flow label previously selected for the data flow. Traffic Class field 514 is filled with the traffic class indicator previously selected for the data flow. Next destination client 115 fills in Response code field 516. This field is used to indicate whether the response is positive or negative. In this example, as the response is coming from the destination client, the response is positive. Next, Number of Node Addresses field 518 is filled. Here, destination client 115 will insert a “3” indicating that three network addresses are following. The first of these address fields, 520 in the present example, is to be filled with the address of the destination of the original flow setup or change packet, to which the present packet is being sent as a response. In this case, destination client 115 inserts its own address into field 520. The remaining address fields are to be filled with the addresses of the nodes via which the response packet is to be carried. Thus, destination client 115 inserts the address of router 110b into field 522 and the address of router 110a into field 524. Once the addresses are inserted, destination client 115 can fill the Option Length field 510 to indicate the total length of the fields contained within the scope of the present option. The destination client 115 then fills in Header Extension Length field 506 to indicate the length of the present extension header, finishes inserting any additional information into the packet, and forwards the packet to source client 105. As in the case of the flow setup or change packet, it is possible to add more extension headers to the response packet as well.

In contrast to the above discussion, a negative response can be sent to the source node from any intermediate node along the route. Similar in structure to the positive response, a negative response includes a negative indication in Response Code field 516. Additionally, Number of Node Addresses field 518 will change depending on where the negative response initiated. The addresses of the packet will change as well. The source address in IPv6 Fixed Header 502 will be the address of the node sending the negative response. The address contained in field 520 of the extension header will be the address of the destination client. As mentioned earlier, this address field is always filled with the address of the destination of the original flow setup or change packet in response to which the present packet is being sent. The addresses that follow in the extension will change accordingly to indicate the nodes between the node sending the negative response and the source node.

FIG. 6 illustrates a packet 600 containing an extension header created by router 110a including a newly proposed route. First, IPv6 Fixed Header 602 is filled. Here, the source address is the address of the node proposing the reroute (in this case router 110a) and the destination address is the address of the node where the reroute will rejoin the old route (router 110b). Next, router 110a fills in Next Header field to indicate there is an extension header following and temporarily leaves Header Extension Length field 606 blank. It fills Option Type field 608 such that it indicates a hop-by-hop extension header for rerouting a data flow is following and temporarily leaves Option Length field 610 blank. Router 110a inserts the data flow label into Flow Label field 612. It also inserts the required bandwidth and traffic class respectively into fields 614 and 616. Next, router 110a fills in Number of Node Addresses field 618. The value in this field is always the number of nodes being added to the route (in this case one) plus two. The address of the source of the data flow (source client 105) and the destination of the data flow (destination client 115) are always inserted into the extension header for record keeping purposes at the newly added node (router 110c). So, “3” is inserted into the Number of Node Addresses field 618. The first address inserted into the extension header is that of source client 105. This address is inserted into field 620. Next, the address of destination client 115 is inserted into field 622. Finally, the addresses of all nodes incident on the proposed reroute appear in the order in which they occur on the reroute before the latter rejoins the original route. In this example, only router 110c appears on the proposed reroute. Consequently, the address of router 110c is inserted into field 622. After inserting final address, router 110a updates Option Length field 610 to indicate the length of the fields falling within the scope of the current option. Next, router 110a updates Header Extension Length to indicate the total length of the extension header. Finally, router 110a adds any additional data to the packet and forwards the packet to router 110c.

FIG. 7 shows packet 700 as constructed by router 110b in the present example in response to the reroute notification sent by router 110a. This response is similar to the response discussed with respect to FIG. 5. First router 110b fills in IPv6 Fixed Header 702. It inserts its own address as the source address and inserts the address of the node which requested the reroute (in this case router 110a) as the destination address. Next router 110b fills in Next Header field 704 to indicate there is an extension header. Header Extension Length field 706 is temporarily left blank. Router 110b fills Option Type field 708 with an indicator that signifies the following extension header is a hop-by-hop extension header for responding to a flow reroute. Option Length field 710 is temporarily left blank. Flow Label field 712 is filled with the cached flow label for this data flow. Similarly, Traffic Class field 714 is filled with the previously selected traffic class for this data flow. Router 110b next fills Response Code field 716. Similar to the discussion of FIG. 5, this field is used to indicate whether the reroute is positively or negatively acknowledged. Only the point where the reroute rejoins the original route (in this example router 110b) can positively acknowledge the reroute. Any point along the reroute can negatively acknowledge the reroute. For this example, router 110b is positively acknowledging the reroute. Next, router 110b inserts a “3” into Number of Node Addresses field 718. A “3” is inserted as the header includes: (1) the address of the source of the data flow (source client 105); (2) the address of the destination of the data flow (destination client 115); and (3) the nodes appearing on the proposed reroute (in this case, only one node, router 110c, falls in this category). Next, router 110b inserts the address of source client 105 into field 720. Next, it inserts the address of destination client 115 into field 722. Finally, router 110b inserts the address of the newly added router 110c into field 724. After completing the extension header, router 110b fills the Option Length field 710 to indicate the total length of the fields falling within the scope of the current option. Next, router 110b fills the Header Extension field 706 to indicate the length of the extension header. Finally, router 110b inserts any additional information into the body of the packet and forwards the packet back towards router 110a. In this case, the packet will be forwarded to router 110a via router 110c.

Once router 110a receives the packet, it knows that the new route has been positively acknowledged by all nodes on the new route. Note that when router 110a initiates the reroute, it sends the packet carrying the flow reroute request along the proposed route. When nodes on this route receive the reroute request, they verify that they have the resources to support the flow. If they do, they allocate the desired resources to the flow, cache information related to the route (including the flow label), and forward the packet to the next node on the proposed reroute. Otherwise, they discard the packet carrying the flow reroute request, and send a negative response to the node which initiated the flow reroute request (router 110a in the present example.) Since only the node where the proposed reroute merges with the original route can send a positive response to a flow reroute request (which happens only if all intermediate nodes have forwarded the reroute request along the proposed route), receiving a positive response from router 110b indicates to router 110a that all nodes and links on the proposed reroute can support the rerouted flow.

Similar to the discussion of FIG. 5, a negative response message can be sent to the node requesting a reroute as well. This message can be initiated by any node along the reroute. The message indicates that the newly selected route is unable to handle the requirements of the data flow and that a new reroute must be selected.

FIG. 8 illustrates packet 800 created by source client 105 to signal the termination of a data flow. Initially, source client 105 fills in the source and destination addresses in IPv6 Fixed Header 802. In this case, the source address is the address of source client 105 and the destination address is the address of destination client 115. Next, source client 105 sets Next Header field 804 to indicate there is an extension header following and temporarily leaves Header Extension Length field 806 blank. Source client 105 next sets Option Type field 808 to indicate a hop-by-hop extension header for terminating a data flow is following. Temporarily, Option Length field 810 is left blank until the extension header is completed. Source client inserts the previously selected traffic class indicator into Traffic Class field 812, and then inserts the previously selected flow label into Flow Label field 814. Next, source client 105 fills Option Length field 810 to indicate the total length of the fields falling within the scope of the current option, and then fills the Header Extension Length field 806 to indicate the total length of the extension header. After finalizing the data packet (e.g., including any data payload not included in header fields), source client 105 forwards the packet to the next node on the route to destination client 115. Since, as described before, each node on the route associated with the data flow stores the corresponding flow label as well as the route to the destination of the flow, the packet carrying flow termination indication can be forwarded hop-by-hop via the nodes incident on the route. This is the reason the flow termination option does not include addresses of nodes other than those of the source and the destination of the flow.

As the termination packet is forwarded through the route, each intermediate node processes the information similarly. First, the intermediate node checks Option Type field 808 and determines the packet indicates a flow termination. Next, the intermediate node checks Flow Label field 814 to determine which flow is being terminated. The node uses this information to find the stored route in its cache, identifies the node (if any) that occurs next on the route, and then deletes the route and the accompanying flow label. The node next forwards the packet to the next node on the route (identified in the previous step). If the node that appears next on the route is the destination of the flow, the node forwards the packet to the destination address contained in IPv6 Fixed Header 802. Once destination client 115 receives the packet, it, too, first checks Option type field 808 to determine the packet is a flow termination packet. It checks Flow Label 814, and similar to the intermediate nodes, deletes the stored route. Finally, destination client 115 checks the non-header information contained in the packet for any additional data relating to the data flow.

The use of the flow termination feature described above is optional. At each node on the route associated with the data flow, the cache entries associated with the flow and the corresponding resource allocations are controlled via a timer. If a node does not receive any packet associated with the data flow for a certain amount of time, the corresponding cache entries and resource allocations are erased. The flow termination feature helps speed up this process by eliminating the need for a node to wait for a corresponding time-out interval before erasing the entries and resource allocations.

By utilizing the extension headers provided in IPv6 as discussed above, several advantages over the prior art are realized. Primarily, a route change can be made immediately at a node where a link has failed. The node can quickly determine a new route and alter the data flow to follow this new route while simultaneously reporting the new route to the unaffected nodes in the route. By doing this, the unaffected nodes are updated with a new route listing without interrupting delivery of the data flow. Another advantage over the prior art is that routes can be changed at any time by a source node. If the requirements for a data flow change for some reason, a source node merely needs to send a flow setup or change packet indicating a new bandwidth or traffic class requirement as well as a new route if needed. In this case, if the route has changed, the cache entries associated with the flow at nodes that do not appear on the new route are timed out as described earlier. Alternatively, the source node may send a termination packet first which will be forwarded along the old route, followed by a flow setup or change packet that will follow the new route. If this latter method is used, cache entries and resource allocations at nodes on the old route are explicitly erased before the new route is established. In either case, a source client can quickly change routes seamlessly (without losing any data) by dynamically creating a new route that conforms to the requirements of the data flow. Yet another advantage is that a source client can force a data flow to follow a selected route without inserting the route into every packet of the data flow. This lowers the size of each packet in the data flow and increases efficiency.

The embodiment shown in FIGS. 3a-c as well as the data packets shown in FIGS. 4-8 are merely shown by way of example. One of ordinary skill in the art will recognize additional embodiments and advantages not fully illustrated above. For example, additional formats of the extension headers can be used as well as alternate request/response schemes with regards to new routes. Also, additional requirements can be placed on the individual network links beyond available bandwidth. Other requirements could include minimum wait times, a certain signal-to-noise ratio (in wireless networks), minimum total number of links, etc. Additionally, alternate well known methods of route construction can be used by the source or rerouting nodes.

1. A method of routing a data flow through a data network, the method comprising the steps of:
(1) creating a data flow at a source node;
(2) determining an optimized source-destination route at said source node;
(3) inserting said route along with a corresponding flow label into an extension header of a first packet of said data flow;
(4) forwarding said data flow through any intermediate nodes along said route to said destination node.

2. The method of claim 1, wherein step (4) further comprises caching said route and said flow label at said intermediate nodes.

3. The method of claim 2, further comprising:
(5) forwarding additional packets belonging to said data flow along said route from said source node to said intermediate nodes, said additional packets containing said flow label and not said route; and
(6) identifying said route at each of said intermediate nodes based upon said flow label in said additional packets and forwarding said additional packets to said destination node based upon said identified route.

4. The method of claim 3, further comprising:
(7) determining a new route at an intermediate node if a link between said intermediate node and another node along said original route is unusable.

5. The method of claim 4, where step (7) further comprises creating a new packet, said new packet including said flow label and said new route, and forwarding said new packet to each node on said new route.

6. A method for directing a data flow through a data network, said data network containing a plurality of nodes, said method comprising the steps of:
(1) initiating said data flow at a source node;
(2) determining an optimized route through said data network from said source node to a destination node;
(3) formatting a first packet of said data flow to include an extension header, said extension header including said optimized route along with a flow label chosen specifically to uniquely correspond to said data flow;
(4) forwarding said first packet from said source node to said destination node via any intermediate nodes along said optimized route;
(5) caching at said intermediate nodes said flow label and said optimized route contained in said first packet;
(6) forwarding any additional packets of said data flow to said destination node via said intermediate nodes, said additional packets containing said flow label but not containing said optimized route;
(7) identifying said optimized route at said intermediate nodes based upon said flow label contained in said additional packets;
(8) forwarding said additional packets from said intermediate nodes toward said destination node based upon said identified optimized routes.

7. A system for routing a data flow through a data network, the system comprising:
means for creating a data flow at a source node;
means for determining an optimized source-destination route at said source node;
means for inserting said route along with a corresponding flow label into an extension header of a first packet of said data flow;
means for forwarding said data flow through any intermediate nodes along said route to said destination node.

8. The system of claim 7, wherein means for forwarding further comprises caching said route and said flow label at said intermediate nodes.

9. The system of claim 8, further comprising:
means for forwarding additional packets belonging to said data flow along said route from said source node to said intermediate nodes, said additional packets containing said flow label and not said route; and
means for identifying said route at each of said intermediate nodes based upon said flow label in said additional packets and forwarding said additional packets toward said destination node based upon said identified route.

10. The system of claim 9, further comprising:
means for determining a new route at an intermediate node if a link between said intermediate node and another node along said original route is unusable.

11. The system of claim 10, wherein said means for determining a new route further comprises creating a new packet, said new packet including said flow label and said new route, and forwarding said new packet to said another node along said original route via new intermediate nodes on said new route.

12. A computer readable product embodied on a computer readable medium for routing a data flow through a data network, comprising:
first computer executable instructions for creating a data flow at a source node;
second computer executable instructions for determining an optimized source-destination route at said source node;
third computer executable instructions for inserting said route along with a corresponding flow label into an extension header of a first packet of said data flow;
fourth computer executable instructions for forwarding said data flow through any intermediate nodes along said route to said destination node.

13. The computer product of claim 12, wherein said fourth computer executable instructions further comprises caching said route and said flow label at said intermediate nodes.

14. The computer product of claim 13, further comprising:
fifth computer executable instructions for forwarding additional packets belonging to said data flow along said route from said source node to said destination node via said intermediate nodes, said additional packets containing said flow label and not said route; and
sixth computer executable instructions for identifying said route at each of said intermediate nodes based upon said flow label in said additional packets and forwarding said additional packets toward said destination node based upon said loaded route.

15. The computer product of claim 14, further comprising:
Seventh executable instructions for determining a new route at an intermediate node if a link between said intermediate node and another node along said original route is unusable.

16. The computer product of claim 15, wherein said seventh executable instructions further comprises creating a new packet, said new packet including said flow label and said new route, and forwarding said new packet to said another node along said original route via new intermediate nodes on said new route.
